(19) United States
(12) Patent Application Publication
(10) Pub. No.: US 2019/0200810 A1
(43) Pub. Date: Jul. 4, 2019

(54) COOKWARE GRASPING DEVICE

(71) Applicant: George Tyler Pearson, Powhatan, VA (US)

(72) Inventor: George Tyler Pearson, Powhatan, VA (US)

(21) Appl. No.: 16/027,614

(22) Filed: Jul. 5, 2018

Related U.S. Application Data
(60) Provisional application No. 62/534,811, filed on Jul. 20, 2017.

(51) Int. Cl. A47J 45/10

(52) U.S. Cl. CPC A47J 45/10

(57) ABSTRACT

Described herein is a cookware grasping and moving device. The device contains a handle portion and a grasping and resting portion. The handle portion is extendable a length and configured for removable receipt on the grasping and resting portion. The grasping and resting portion having adjustable dimensions configured for attachment and securing the item of cookware.

### CROSS REFERENCE TO RELATED APPLICATIONS

This application claims priority to U.S. Provisional Patent Application No. 62/534,811 filed 20 Jul. 2017 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The disclosure of the present application relates generally to a grasping device for cookware to aid in the movement and transport of the cookware to and from a heating source.

### BACKGROUND

Often when cooking, a typical user will need to move a heated container from a heat source, such as an oven. Typical solutions for this movement generally utilize heat resistant fabric items, such as oven mitts or gloves, or pot holders and hot pads for covering a user's hands during grasping, removal, and transport. Still other solutions generally utilize additional utensils, such as tongs.

These solutions generally fail to meet the needs of the market as these devices generally only cover a portion of the user's hands and arms or are difficult to use in securing large and heavy containers. Therefore, there is a need within the market for an improved cookware grasping device that generally allows a user to remove a hot item/container from a heat source. Preferably this device is configured for robust attachment to a cookware item, is heat resistant, configured for attachment to multiple shapes and sizes, and configured to allow for both placement and removal from the heat source.

### SUMMARY OF THE INVENTION

The device of the present disclosure is generally a mechanical cookware grasping and maneuvering device that is adjustable for the grasping of and placement upon a variety of cookware containers and sizes for moving the cookware into and from a heat source, such as an oven.

The cookware grasping device of the present disclosure is generally configured to provide grasping support and resting support to a cookware item placed within and removed from a heat source, such as an oven. The materials of the device are heat resistant and configured for resiliency in high heat environments.

The device is comprised of a handle portion having a telescopic arm portion in removable communication with an adjustable grasping and resting portion. The grasping portion having a plurality of arms radiating from a center attached end to a free end. The arms having a length that is adjustable between the attached end and the free end, wherein the dimension of the grasping portion is movable to secure a number of sizes shapes, and types of cookware. This free end is substantially finger-like and has an adjustable height, wherein the free end is adapted to secure varying heights of cookware.

The handle end is configured in an adjustable assembly having a first release button positioned on a top of the handle and a second release button positioned on the arm portion, wherein operation of the release buttons is configured to allow a user to separate the handle from the grasping portion.

The handle having an adjustable length through a nested/telescopic assembly, wherein buttons received within apertures allow for an adjustment of the length of the handle arm.

In use, the grasping portion is generally sized to be received around an item of cookware to offer grasping and resting support for the cookware and remains in an engaged position in communication with the cookware when placed into an oven. The handle arm portion is selectively and removably received in the grasping portion, wherein the user will utilize the handle to remove and place the item of cookware that is engaged within the grasping portion into and out of the heat source.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 shows the top of device, according to the present disclosure;

FIG. 2 shows a perspective view of the open device, according to the present disclosure;

FIG. 3 shows a perspective view of device, according to the present disclosure;

FIG. 4 shows a side view of the open device, according to the present disclosure;

FIG. 5 shows the side of the handle for the device in an extended position, according to the present disclosure;

FIG. 6 shows the right side of device, according to the present disclosure;

FIG. 7 shows the left side of device, according to the present disclosure;

FIG. 8 shows the front of device, according to the present disclosure;

FIG. 9 shows the bottom of device, according to the present disclosure; and

FIG. 10 shows the back of device, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter process, process or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The device of the present disclosure is generally configured as a grasping or holding device for generally being affixed to an item of cookware for moving the cookware into and out of a heat source without exposing a user to the high temperature of the heat source heated item of cookware.

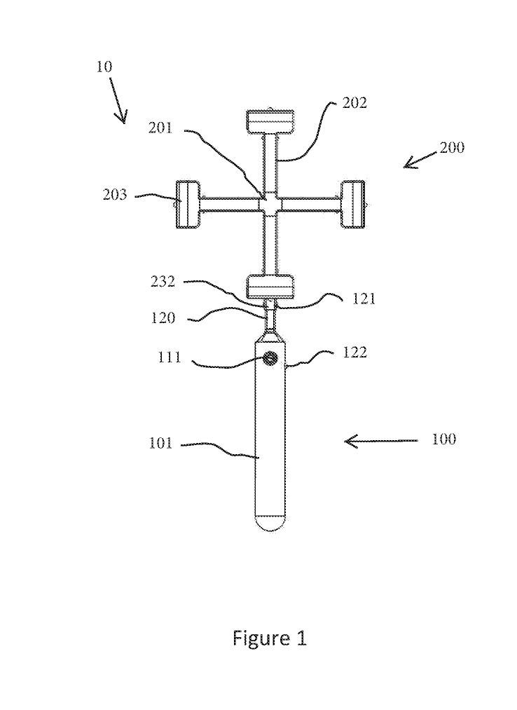

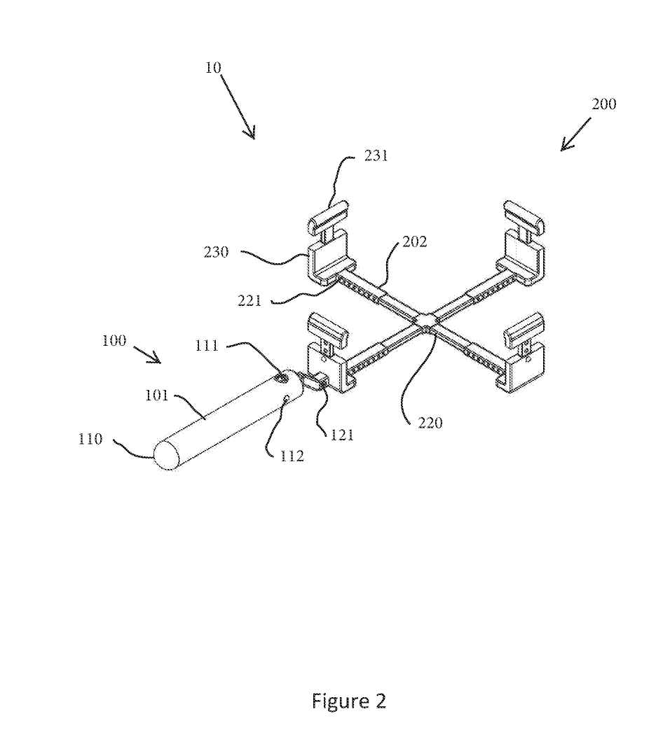

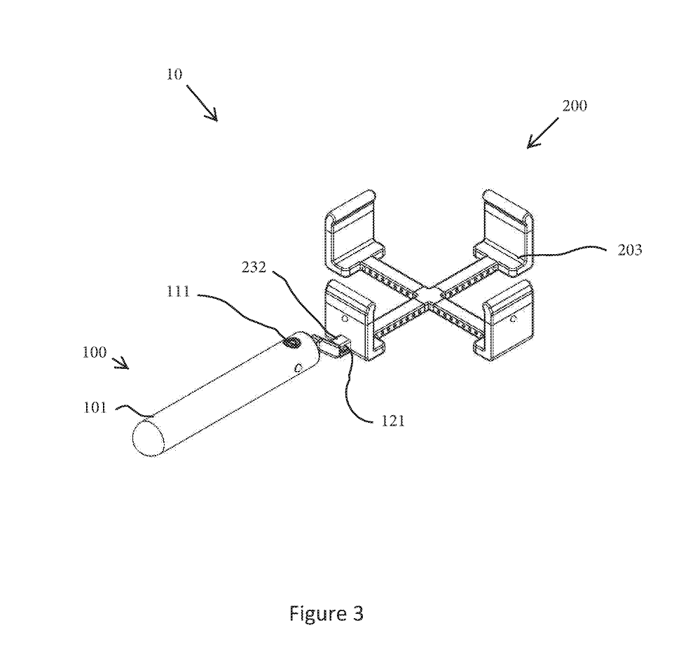

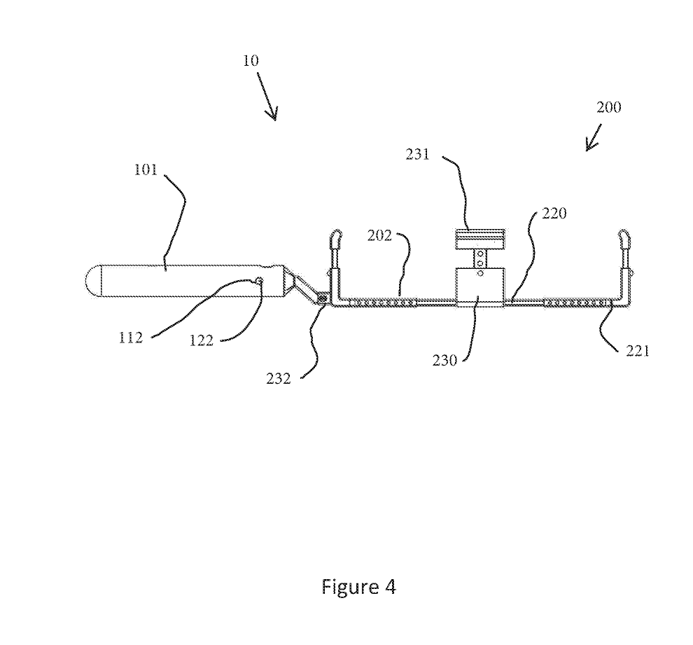

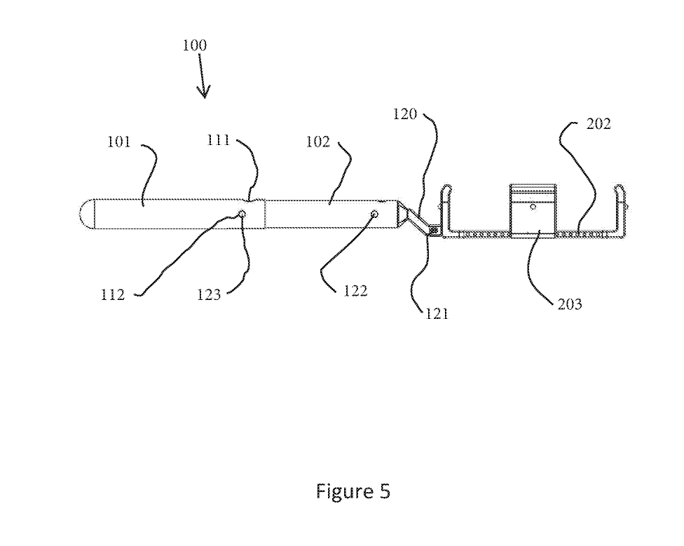

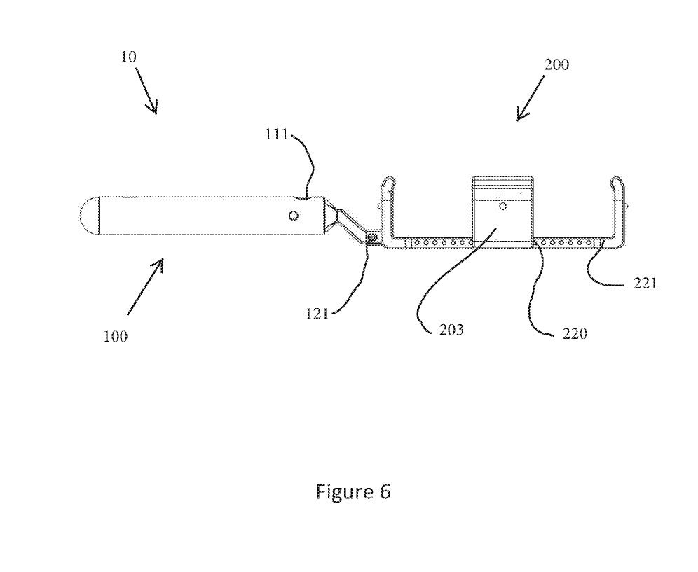

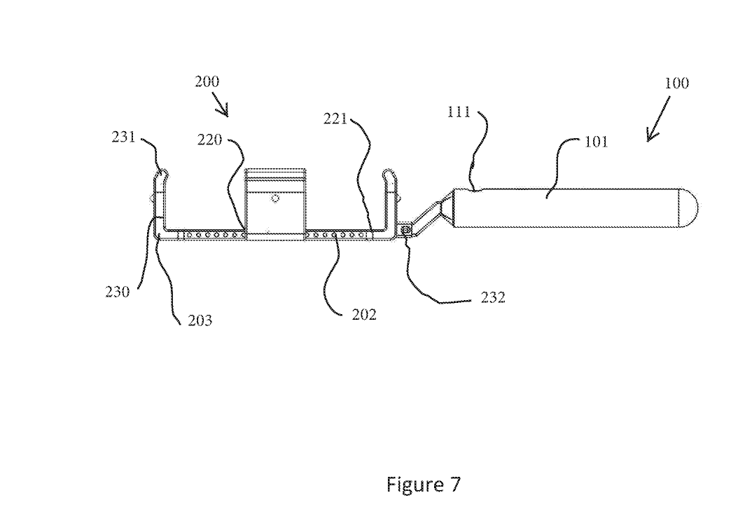

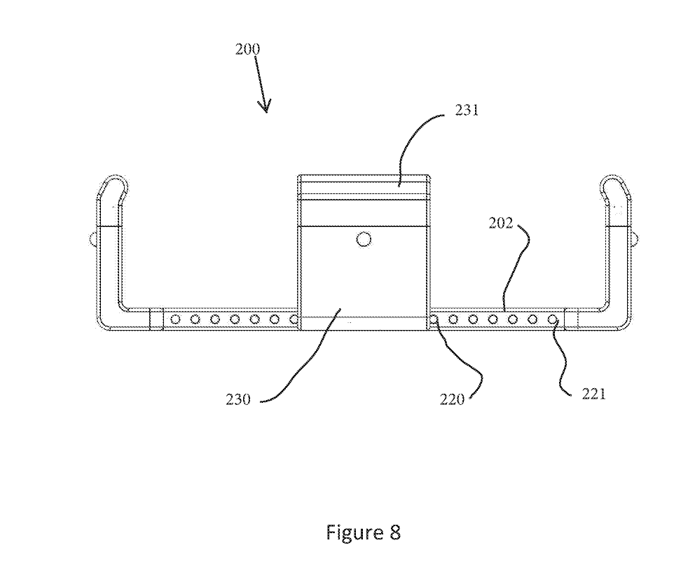

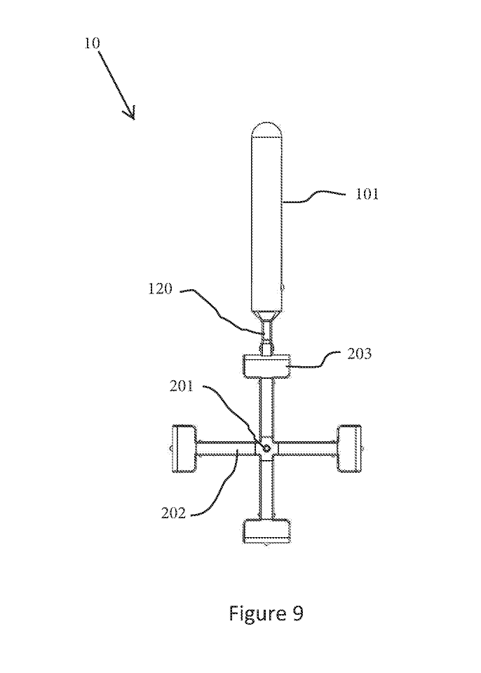

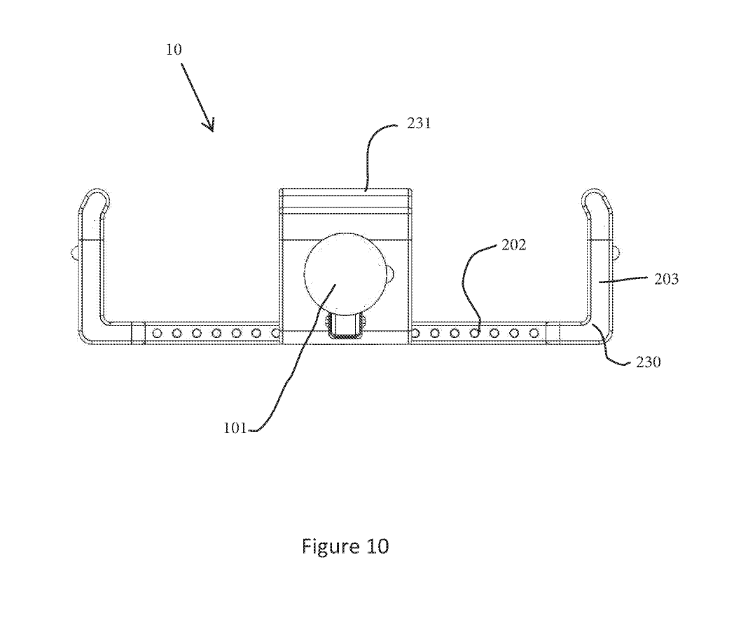

Referring to the figures, FIG. 1 to FIG. 10 show the cookware grasping device of the present invention and generally referred to as device 10. The device 10 of the present invention is generally adapted to provide a combination of grasping support and resting support to an individual cookware item placed within and removed from a heat source, such as oven.

Accordingly, the materials of the device 10 are comprised of heat resistant materials, such as, but not limited to, metals, silicones, ceramics, and other similar materials configured for resiliency and durability in high-heat environments. The device 10 is comprised of a handle portion 100 in removable communication with an adjustable grasping and resting portion 200.

The adjustable grasping and resting portion 200 comprised of a plurality of arm portions 202 radiating outward from a center hub 201. Each arm 202 of the plurality of arm portions 202 having an attached end 220 and extending a length to a free end 221 opposed the attached end 220, wherein the length of the arm 202 is adjustable by moving the free end 221 opposite the attached end 220 outward relative to the center hub 201. Accordingly, the overall dimensions of the grasping and resting portion 200 can be adjusted to secure a multitude of sizes, shapes, and dimensions of an individual item of cookware.

The free end 221 of the arm portions 202 having a grasping member 203 generally forming a finger-like projection for receiving both the bottom and sidewall of the cookware item. The grasping member 203 extending perpendicular to the arm portions 202 a height from a fixed end 230 to a movable end 231 opposite the fixed end 230. The grasping member 203 generally forming an L-shape with the fixed end 230 being the base of the L-shape and the movable end 231 being the leg portion of the L-shape and comprised of a resilient material, such as a temperature resistant silicone, for gripping the cookware item. Accordingly, the resilient material of the grasping member 203 provides a surface with increased friction in securing the cookware item within the grasping and resting portion 200 and dissipating retained heat from a heated cookware item.

In the preferred embodiment of the present disclosure, the grasping and resting portion 200 is comprised of four arm portions 202 spaced equidistant around the central hub 201 and radiating outward opposite the central hub 201.

The handle end 100 is provided in an adjustable assembly, wherein a length of the handle end 100 can be extended through a handle length adjusting means. Accordingly, the handle end 100 is comprised of an outer portion 101 and inner portion 102 provided in a nested telescopic receipt within the outer portion 101. The outer portion 101 generally hollow to allow the receipt of the inner portion 102 and having an outer surface 110.

In the preferred assembly for the adjustable length means, the outer portion 101 of the handle 100 has a first aperture 112 configured to enable the adjustable length of the handle portion through a selective communication with a pair of raised nodes 122, 123. The raised nodes 122, 123 generally comprised of spring loaded detents configured for selective receipt within the first aperture 112 to allow a user to generally move the nested assembly of the outer portion 101 and inner portion 102 between a pair of positions in the form of a collapsed position or extended position allowing for an adjustment to the length of the handle 100. In this preferred assembly a first raised node 122 of the pair of nodes is positioned adjacent to an attached end 120 of the inner portion 102 and a second raised node 123 of the pair of nodes is positioned distal the first raised node 122 opposed the attached end 120.

The outer surface 110 comprised of a resilient material, similar to the grasping member 203, such as a temperature resistant silicone, for providing an increased grip for the user of the device 10. The resilient material of the outer surface 110 may further aid in dissipating retained heat from a heated cookware item.

The handle end 100 inner portion 102 having the attached end 120 extending distal the outer portion 101 and configured for removable attachment to the grasping and resting portion 200. The preferred connection utilizes a pair of release buttons 111, 121 enabling for the release and connection of the handle end 100 and grasping and resting portion 200. The first release button 111 coupled to the second release button 121, wherein manipulation of the first release button 111 moves the second release button 121 inward as if the button 121 where manually manipulated by applying a force, such as pressing. The attached end 120 generally adapted with a shape for receipt with a sleeve member 232 posited on an outer portion of at least one of the grasping members 203 opposite the arm portion 202. The sleeve member 232 including an aperture for the receipt of the second release button 121, wherein the second release button 121 is generally a raised boss or spring-loaded detest sized for receipt within the aperture of the sleeve member 232.

The attached end 120 may be provided in angled assembly to generally align the handle portion 100 at a central position along a height of the grasping and resting portion 200 to balance the device 10 and increase the ability of the device 10 to support large and potentially heavy items.

In use of the device 10, the grasping portion 102 is generally sized by a user to be received around an item of cookware to offer grasping and resting support for the cookware and remain in an engaged position when placed into an oven. Accordingly, the user will generally utilize the various adjustment means including, but not limited to, moving the arm portions 202 and grasping members 203 to align with the cookware dimensions. The handle portion 100 is then selectively and removably received in the grasping and resting portion 200, wherein the user will utilize the engaged device 10 to remove and place the item into and out of the oven. The first release button 111 and second release button 121 will aid in these process allowing the user to easily attach and detach the handle 100 from the grasping and resting portion 200.

While the invention has been described above in terms of specific embodiments it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An apparatus configured to secure a cookware item and aid in the placement and removal of the cookware item from a heat source, the apparatus comprising:
a handle portion, the handle portion having an adjustable length, the handle portion removably received on a grasping and resting portion; and
the grasping and resting portion having adjustable dimensions and configured for the receipt of the cookware item, the grasping and resting portion comprising:
a central hub;
a plurality of arm portions, the arm portions having a length, the length movable a distance relative to the central hub; and
a grasping member, the grasping member extending perpendicular to the length of the plurality of arm portions.

2. An apparatus as in claim 1, wherein the grasping member has a height, the height adjustable.

3. An apparatus as in claim 1, wherein the handle portion is comprised of an outer portion and an inner portion, the inner portion telescopically received in the outer portion.

4. An apparatus as in claim 3, wherein the inner portion is moved to a detached position relative to the grasping and resting portion through a release button on the outer portion of the handle.

5. A heat resistant device for handling a cookware item, the device comprising:
a handle portion, the handle portion including:
an outer portion; and
an inner portion configured for nested receipt in the outer portion, the inner portion including an attached end, the attached end configured for removable coupling with a grasping and resting portion; and
the grasping and resting portion, the grasping and resting portion
including:
a central hub;
a plurality of arm portions, the arm portions having an attached end affixed to the central hub and a free end extending an adjustable length opposed the attached end; and
a grasping member, the grasping member positioned adjacent the free end and extending perpendicular to the length, the grasping member having a fixed end and a movable end extending an adjustable height opposed to the fixed end.

6. A device as in claim 5, wherein the outer portion includes an outer surface, the outer surface comprised of a heat resistant coating.

7. A device as in claim 5, wherein the outer portion of the handle portion includes a release button, the release button coupled to the inner portion attached end configured to enable the removable coupling of the grasping and resting portion.

8. A device as in claim 7, wherein the grasping and resting portion includes four arm portions, the arm portions spaced equidistant around the central hub.

9. A device as in claim 8, wherein the grasping member is comprised of a heat resistant coating.

10. A device as in claim 7, wherein the release button is a coupled to a second release button adjacent to the attached end of the inner portion.

11. A device configured to aid in handling a cookware item enabling transfer to and from a heat source, the device heat resistant and comprising:
a handle portion, the handle portion including:
an outer portion having an outer surface, a first aperture, and a first release button; and
an inner portion configured for nested receipt in the outer portion, the inner portion including an attached end, the attached end configured for removable coupling with a grasping and resting portion through a second release button coupled to the first release button, a first raised node and a second raised node, the first raised node and second raised node sized for receipt in the first aperture; and
the grasping and resting portion, the grasping and resting portion
including:
a central hub;
a plurality of arm portions, the arm portions having an attached end affixed to the central hub and a free end extending an adjustable length opposed the attached end; and
a grasping member, the grasping member positioned adjacent the free end and extending perpendicular to the length, the grasping member having a fixed end and a movable end extending an adjustable height opposed to the fixed end.

12. A device as in claim 11, wherein the outer surface is comprised of a heat resistant coating.

13. A device as in claim 11, wherein the grasping and resting portion includes four arm portions, the arm portions spaced equidistant around the central hub.

14. A device as in claim 13, wherein the grasping member is comprised of a heat resistant coating.
